(19) United States
(12) Patent Application Publication
(10) Pub. No.: US 2016/0276760 A1
(43) Pub. Date: Sep. 22, 2016

(54) HIGH-CURRENT STACK TYPE HOT-PLUGGABLE CONNECTOR

(71) Applicant: Amphenol East Asia Electronic Technology (Shenzhen) Ltd., Shenzhen (CN)

(72) Inventor: Yiqiang LUO, Shenzhen (CN)

(21) Appl. No.: 14/659,912

(22) Filed: Mar. 17, 2015

(51) Int. Cl. H01R 12/57; H01R 13/74; H01R 24/76

(52) U.S. Cl. CPC H01R 12/57; H01R 24/76; H01R 13/748; H01R 2107/00

(57) ABSTRACT

The present disclosure relates to a field of high-current connector, and specifically relates to a high-current stack type hot-pluggable connector includes terminal assemblies, an outer casing assembly and support assemblies. The outer casing assembly has a hollow structure and the terminal assembly can be accommodated therein. The support assemblies are disposed at two sides of the outer casing assembly and can be fixed on a PCB. The terminal assembly can be a structure of one layer or a stack structure of multiple layers. The high-current of the present disclosure can quickly adjust the cross sectional areas of the terminals according to magnitude of the current, and can be hot-pluggable.

### BACKGROUND OF THE INVENTION

1. Field of the Invention

The present disclosure relates to high-current a connector field, specifically relates to a high-current stack type hot-pluggable connector.

2. Description of the Related Art

In high-current environment, the safety is the first criterion for judging quality of a connector product. Freedom from bias is an important factor in the safety of the connector and plays an important role for the safety and reliability of the connector.

At present, the high-current connector has a problem of unable to quickly adjust cross sectional areas of terminals according to magnitude of the current for meeting broader demand in the current. In addition, the safety of implementing hot plugging function in the high-current connector is also an important topic.

### SUMMARY OF THE INVENTION

An objective of the present disclosure is to provide a high-current stack type hot-pluggable connector, and more particularly to a high-current connector capable of quickly adjusting cross sectional areas of the terminals according to magnitude of the current and being hot pluggable.

The high-current stack type hot-pluggable connector includes terminal assemblies, an outer casing assembly and support assemblies. The outer casing assembly has a hollow structure to accommodate the terminal assembly. The support assemblies are disposed at two sides of the outer casing assembly and can be fixed on a PCB. The terminal assembly can be a structure of one layer or a stack structure of multiple layers.

In a further preferred embodiment, the multiple terminal assemblies to be stacked can be different types.

In a further preferred embodiment, the terminal assembly includes a contact end and a riveting end, and the contact end includes two contact point rows.

In a further preferred embodiment, the riveting end can be fastened on the support assembly by a stud.

In a further preferred embodiment, the outer casing assembly includes terminal cavities longitudinal disposed along the outer casing assembly. The terminal cavities are four in number and four sets of terminal assemblies can be accommodated therein respectively.

In a further preferred embodiment, the outer casing assembly includes support slots disposed at two side casing walls thereof.

In a further preferred embodiment, the support assembly includes plates and wing-like members.

In a further preferred embodiment, the plate can be fastened into the support slot.

In a further preferred embodiment, the outer casing assembly includes retaining hooks disposed at an inner side of the entrance of the support slot.

In a further preferred embodiment, the outer casing assembly includes protrusions disposed at wall edges of the support slot respectively for stopping the wing-like members.

In a further preferred embodiment, the outer casing assembly includes stud slots disposed on the casing wall of the support slot near the entrance thereof.

In a further preferred embodiment, the studs of the riveting ends can be passed through the stud slots to be fastened on the plates.

In a further preferred embodiment, the support assemblies are fastened in the PCB by using screws and nuts. Each of the wing-like members is provided with a fixing hole, the screws are passed through the fixing holes and the PCB respectively, and other ends of the screws are fastened by the nuts.

After the aforesaid technology solution is adopted, the connector of the present disclosure can have following advantages.

Compared with traditional high-current connector, the connector of the present disclosure can quickly adjust the cross sectional areas of the terminals, so the adaptability and the practicability are improved efficiently. In a further preferred embodiment, the terminal assemblies to be stacked can be different types according to condition of actual use, so as to further improve the adaptability of the practicability of this technology solution. In a further preferred embodiment, the retaining hook and protrusions can be used to prevent the support assemblies fastened in the support slots from being loosed and dropped forwardly or backwardly, so the reliability of the connector can be ensured.

### BRIEF DESCRIPTION OF THE DRAWINGS

The detailed structure, operating principle and effects of the present disclosure will now be described in more details hereinafter with reference to the accompanying drawings that show various embodiments of the present disclosure as follows.

FIG. 1 shows an exploded view of a high-current stack type hot-pluggable connector of the present disclosure.

FIG. 2 shows two contact point rows of the connector of the present disclosure.

FIG. 3 shows a retaining hook of the connector of the present disclosure.

FIG. 4 shows a protrusion for stopping the wing-like member.

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

It will be understood that, although the terms ‘first’, ‘second’, ‘third’, etc., may be used herein to describe various elements, these elements should not be limited by these terms. The terms are used only for the purpose of distinguishing one component from another component. Thus, a first element discussed below could be termed a second element without departing from the teachings of embodiments. As used herein, the term “or” includes any and all combinations of one or more of the associated listed items.

As shown in FIG. 1, a high-current stack type hot-pluggable connector includes terminal assemblies 1, an outer casing assembly 2 and support assemblies 3. The outer casing assembly 2 has a hollow structure to accommodate the terminal assemblies 1. The support assemblies 3 are disposed at two sides of the outer casing assembly 2 and can be fixed on a PCB. The terminal assembly 1 can be a structure of one layer or a stack structure of multiple layers.

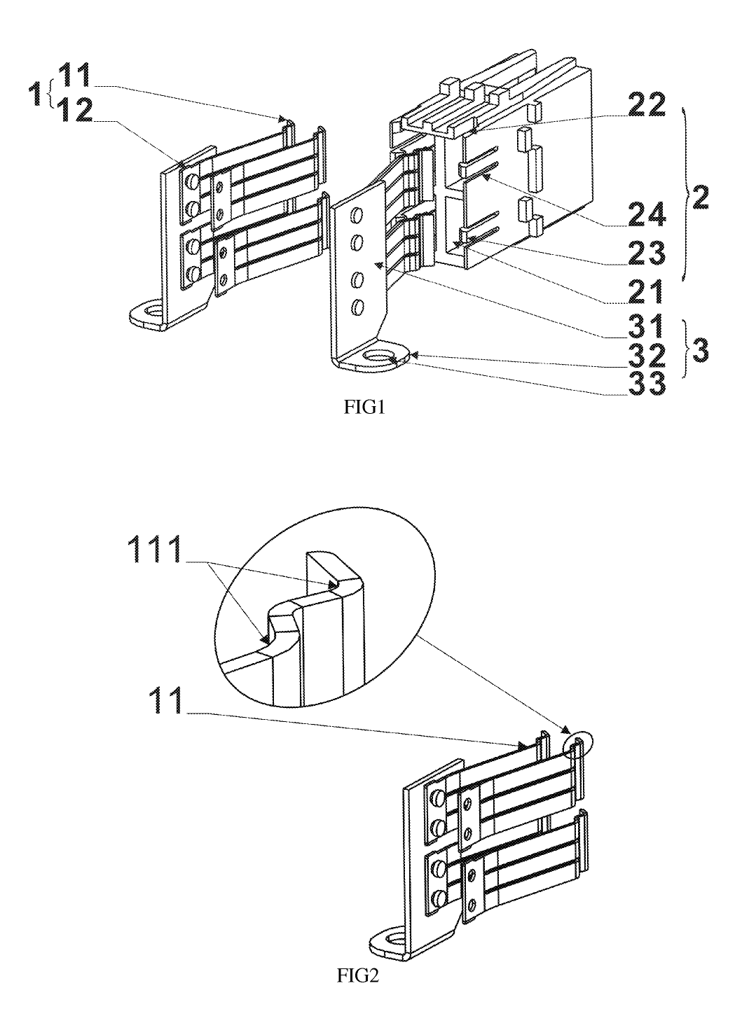

As shown in FIG. 2, on a basis of the aforesaid implementation, the terminal assembly 1 includes a contact end 11 and a riveting end 12. The contact end 11 includes two contact point rows 111.

On the basis of the aforesaid implementation, the riveting end 12 can be fastened on the support assembly 3 by studs.

On the basis of the aforesaid implementation, the outer casing assembly 2 includes terminal cavities 21 longitudinal disposed along the outer casing assembly 1. The terminal cavities 21 are four in number and the four sets of the terminal assembly 1 can be accommodated therein.

On the basis of the aforesaid implementation, the outer casing assembly 2 includes a support slot 22 disposed at two side casing walls thereof.

On the basis of the aforesaid implementation, the support assembly 3 includes plates 31 and wing-like members 32.

On the basis of the aforesaid implementation, the plate 31 can be fastened into the support slot 22.

As shown in FIG. 3, on the basis of the aforesaid implementation, the outer casing assembly 2 includes retaining hooks 23 disposed at an inner side of the entrance of the support slot 22.

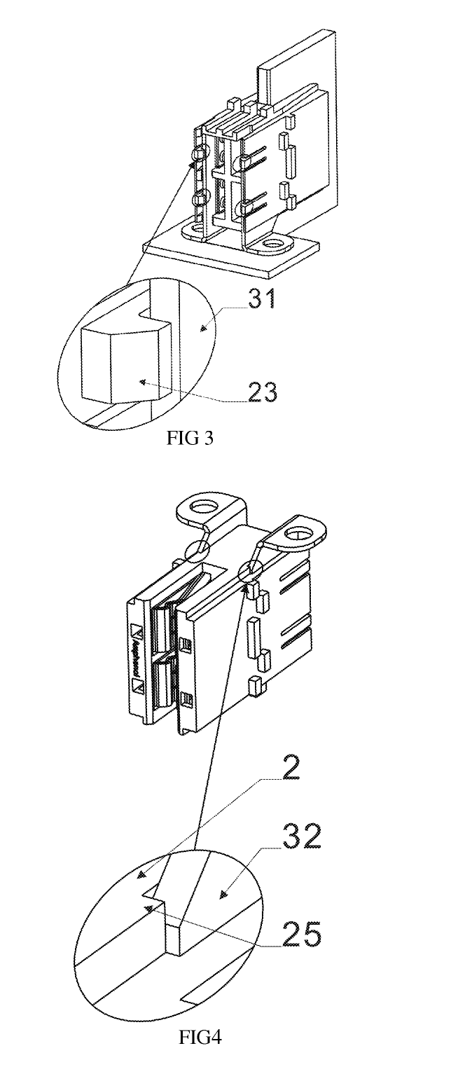

As shown in the FIG. 4, on the basis of the aforesaid implementation, the outer casing assembly 2 includes protrusions 25 disposed at wall edges of the support slot 22 respectively for stopping the wing-like members 32.

On the basis of the aforesaid implementation, the outer casing assembly 2 includes stud slots 24 disposed on the casing wall of the support slot 22 near the entrance thereof.

On the basis of the aforesaid implementation, the studs of the riveting ends 12 can penetrate the stud slots 24 to be fastened on the plates 31.

As shown in FIG. 1, on the basis of the aforesaid implementation, the support assemblies 3 are fastened on the PCB by using screws and nuts. Each of the wing-like members 32 is provided with a fixing hole 33, and the screws are passed through the fixing holes 33 and the PCB respectively, and other ends of the screws are fastened by the nuts.

On the basis of the aforesaid implementation, the high-current stack type hot-pluggable connector can be implemented by following steps:

A step of matching the terminals: according to specific usage demand and magnitude of the current, appropriate number and types of the terminals are selected to be stacked together to form the terminal assembly.

An assembly step: four sets of the terminal assembly 1 are inserted into the four terminal cavities 21, and the support assemblies 2 are fastened into the support slots 22 on the two side casing walls of the outer casing assembly 2. By using a manner of riveting stud, the studs are passed through the stud slots 24 and connected therewith, to fasten the plate 31 of the support assembly 2 and the riveting end 12 of the terminal assembly 1 integratedly.

A connection step: an end of the terminal assembly 1 of the connector is connected with the PCB, and other end of the terminal assembly 1 is connected with conductive block via the contact end 11.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A high-current stack type hot-pluggable connector, comprising terminal assemblies (1), an outer casing assembly (2) and support assemblies (3), the outer casing assembly (2) having a hollow structure to accommodate the terminal assemblies, the support assemblies (3) disposed at two sides of the outer casing assembly (2) and able to be fixed on a PCB, wherein the terminal assembly (1) can be a structure of one layer or a stack structure of multiple layers.

2. The high-current stack type hot-pluggable connector according to claim 1, wherein the multiple terminal assemblies (1) to be stacked can be different types.

3. The high-current stack type hot-pluggable connector according to claim 1, wherein each of the terminal assemblies (1) comprises a contact end (11) and a riveting end (12), the contact end (11) comprises two contact point rows (111).

4. The high-current stack type hot-pluggable connector according to claim 3, wherein the riveting end (12) can be fastened on the support assembly (3) by studs.

5. The high-current stack type hot-pluggable connector according to claim 4, wherein the outer casing assembly (2) comprises terminal cavities (21) longitudinal disposed along the outer casing assembly (1), the terminal cavities (21) are four in number and four sets of the terminal assembly (1) can be accommodated therein respectively.

6. The high-current stack type hot-pluggable connector according to claim 1, wherein the outer casing assembly (2) comprises a support slot (22) disposed at two side casing walls thereof.

7. The high-current stack type hot-pluggable connector according to claim 6, wherein the support assembly (3) comprises plates (31) and wing-like members (32).

8. The high-current stack type hot-pluggable connector according to claim 7, wherein each of the plates (31) can be fastened into the support slot (22).

9. The high-current stack type hot-pluggable connector according to claim 8, wherein the outer casing assembly (2) comprises retaining hooks (23) disposed at an inner side of the entrance of the support slot (22).

10. The high-current stack type hot-pluggable connector according to claim 9, wherein the outer casing assembly (2) comprises protrusions (25) disposed on wall edges of the support slot (22) respectively for stopping the wing-like members (32).

11. The high-current stack type hot-pluggable connector according to claim 10, wherein the outer casing assembly (2) comprises a stud slot (24) disposed on casing wall of the support slot (22) at the entrance of the support slot (22).

12. The high-current stack type hot-pluggable connector according to claim 11, wherein the studs of the riveting ends (12) can be passed through the stud slots (24) and fastened on the plates (31).

13. The high-current stack type hot-pluggable connector according to claim 1, wherein the support assemblies (3) are fastened on the PCB by using screws and nuts, each of the wing-like members (32) is provided with a fixing hole (33), the screws are passed through the fixing holes (33) and the PCB, and other ends of the screws are fastened by the nuts.
